(19) United States
(12) Patent Application Publication
(10) Pub. No.: US 2015/0202758 A1
(43) Pub. Date: Jul. 23, 2015

(54) Percussion Unit

(71) Applicants: Rainer Nitsche, Kirchheim/Teck (DE); Christian Bertsch, Markgroeningen (DE); Carsten Diem, Ludwigsburg (DE); Achim Duesselberg, Kirchheim/Teck (DE); Matthias Tauber, Bad Boll (DE); Helge Sprenger, Stuttgart (DE)

(72) Inventors: Rainer Nitsche, Kirchheim/Teck (DE); Christian Bertsch, Markgroeningen (DE); Carsten Diem, Ludwigsburg (DE); Achim Duesselberg, Kirchheim/Teck (DE); Matthias Tauber, Bad Boll (DE); Helge Sprenger, Stuttgart (DE)

(21) Appl. No.: 14/403,724

(22) PCT Filed: May 6, 2013
(86) PCT No.: PCT/EP2013/059379

§ 371 Date: Nov. 25, 2014

(30) Foreign Application Priority Data
May 25, 2012 (DE) 10 2012 208 870.9
May 25, 2012 (DE) 10 2012 208 913.6
May 25, 2012 (DE) 10 2012 208 916.0

(51) Int. Cl. B25D 11/00; B25D 11/12; B25D 16/00

(52) U.S. Cl. CPC B25D 11/005; B25D 16/006; B25D 11/125

(57) ABSTRACT

A percussion unit, especially for a rotary hammer and/or percussion hammer, includes a control unit that is configured for open-loop and/or closed loop control of a drive unit and/or a pneumatic percussion mechanism. The percussion unit further includes a pressure sensor unit that is configured to measure a pressure curve in order to detect at least one state of the percussion mechanism.

### PRIOR ART

There are already known percussion mechanism units, in particular for rotary and/or percussion hammers, comprising a control unit that is provided to control a drive unit and/or a pneumatic percussion mechanism by open-loop and/or closed-loop control.

### DISCLOSURE OF THE INVENTION

The invention is based on a percussion mechanism unit, in particular for a rotary and/or percussion hammer, comprising a control unit that is provided to control a drive unit and/or pneumatic percussion mechanism by open-loop and/or closed-loop control.

A pressure sensor unit is proposed, which is provided to measure a pressure characteristic for the purpose of identifying at least one percussion mechanism state. A “percussion mechanism unit” in this context is to be understood to mean, in particular, a unit provided to operate the percussion mechanism. The percussion mechanism unit may have, in particular, a control unit. The percussion mechanism unit may have a drive unit and/or a transmission unit, provided to drive the percussion mechanism. A “control unit” in this context is to be understood to mean, in particular, a device of the percussion mechanism unit that is provided to control, in particular, the drive unit and/or the percussion mechanism by open-loop and/or closed-loop control. The control unit may preferably be realized as an electrical, in particular an electronic, control unit. A “rotary and/or percussion hammer” in this context is to be understood to mean, in particular, a power tool provided for performing work on a workpiece by means of a rotary or non-rotary tool, wherein the power tool may apply percussive impulses to the tool. Preferably, the power tool is realized as a hand power tool that is manually guided by a user. A “percussion mechanism” in this context is to be understood to mean, in particular, a device having at least one component provided to generate a percussive impulse, in particular an axial percussive impulse, and/or to transmit such a percussive impulse to a tool disposed in a tool holder. Such a component may be, in particular, a striker, a striking pin, a guide element, such as, in particular, a hammer tube and/or a piston, such as, in particular, a pot piston and/or other component considered appropriate by persons skilled in the art. The striker may transmit the percussive impulse directly or, preferably, indirectly to the tool. Preferably, the striker may transmit the percussive impulse to a striking pin, which transmits the percussive impulse to the tool. “Provided” is to be understood to mean, in particular, specially designed and/or specially equipped. The “pressure sensor unit” may comprise, in particular, a pressure sensor and a signal processing unit. A “pressure characteristic” is to be understood to mean, in particular, a time characteristic of a pressure, in particular of the pressure in a space. A “percussion mechanism state” in this context is to be understood to mean, in particular, an operating mode or an operating state of the percussion mechanism. An “operating mode” in this context is to be understood to mean, in particular, a configuration of the percussion mechanism in which it is provided for a particular operating state, in particular for a percussive operating state or an idling operating state. An “operating state” in this context is to be understood to mean, in particular, an operating behavior of the percussion mechanism, such as, in particular, the percussive operating state or the idling operating state. Persons skilled in the art are familiar with further operating states, in particular a percussion intensity and a percussion frequency, that determine the operating behavior of the percussion mechanism. A “percussive operating state” in this context is to be understood to mean, in particular, an operating state of the percussion mechanism in which preferably regular percussive impulses are exerted by the percussion mechanism. Preferably, the percussion mechanism is provided to operate in the percussive state when in a percussion mode. “Regular” in this context is to be understood to mean, in particular, recurring, in particular with a provided frequency. An “idling operating state” in this context is to be understood to mean, in particular, an operating state of the percussion mechanism that is characterized by absence of regular percussive impulses, and/or in which only very weak percussive impulses are exerted upon the striking pin by the striker. “Very weak” in this context is to be understood to mean, in particular, that a percussive intensity corresponds to less than 50%, preferably less than 25%, particularly preferably less than 10% of the percussive intensity in the percussive operating state. Preferably, the percussion mechanism is provided to operate in the idling state when in the idling mode. The percussion mechanism may preferably have suitable devices by means of which it can switch over between the idling mode and the percussion mode. Such devices are known to persons skilled in the art. In particular, the percussion mechanism may have a control sleeve, which is provided to release idling openings, at least to a large extent, in the idling mode, and to close the idling openings, at least to a large extent, in the percussion mode. “To a large extent” in this context is to be understood to mean at least by more than 50%, preferably at least by more than 80%. “Idling openings” in this context are to be understood to mean, in particular, openings, in particular in the hammer tube, that are provided to allow a pressure of a compression space to be equalized with that of an adjoining space. A “compression space” in this context is to be understood to mean, in particular, a space, in particular in the hammer tube, that is delimited by the piston and the striker. In the percussion mode, the piston can accelerate the striker in the direction of the striking pin by means of a piston movement, by compressing the volume enclosed in the compression space, in a percussion direction. The piston is preferably moved cyclically, with a percussion frequency and/or a percussion-mechanism rotational speed, in the percussion direction and contrary to the percussion direction. A “percussion-mechanism rotational speed” in this context is to be understood to mean, in particular, a rotational speed of an eccentric, which preferably moves the piston by means of a connecting rod. If the piston executes one movement cycle upon one revolution of the eccentric, the percussion-mechanism rotational speed corresponds to the percussion frequency. The terms are to be understood as equivalents in the following. In the idling mode, the idling openings are open, at least to a large extent, such that, upon variations in volume of a compression space that are caused by alteration of a distance between the piston and the striker, air can escape, and/or flow into the compression space, through the idling openings. The piston movement then results in no compression, or only little compression, of a volume in the compression space, such that the striker is at most accelerated only slightly by the piston movement. A “slight acceleration” in this context is to be understood to mean, in particular, an acceleration that results in an idling operating state of the percussion mechanism. The percussion mechanism state can be identified, advantageously, by measuring the pressure characteristic. In particular, advantageously, the percussion mode and/or the percussive operating state and/or the percussion frequency can be identified. There is no need for further sensors and/or means for identifying the percussion mechanism state. The control unit can react appropriately to the percussion mechanism state. Faults and/or anomalous operating states and/or operating modes can be identified. The control unit can use the percussion mechanism state to control the percussion mechanism and/or the drive unit by open-loop and/or closed-loop control.

Further, it is proposed that the pressure sensor unit be provided to measure the pressure characteristic in a space that, in at least one percussion mechanism state, is connected in respect of pressure to at least one percussion space and/or compression space delimited by the piston. A “percussion space” in this context is to be understood to mean, in particular, a space, in particular in the hammer tube, that is delimited by the piston and the striking pin and/or that is located in front of the piston in the percussion direction. In particular, the space may surround the hammer tube. “Connected in respect of pressure” in this context is to be understood to mean, in particular, at least one connection that is provided to equalize pressure between two volumes, such as, in particular, an opening, a channel and/or a pressure line. Preferably, the space is connected in respect of pressure to the compression space, at least in the idling mode, via the idling openings in the hammer tube. Preferably, the space may connected in respect of pressure to the percussion space via venting openings in the hammer tube. “Venting openings” in this context are to be understood to mean, in particular, openings, in particular in the hammer tube, that are provided to allow a pressure of the compression space to be equalized with that of an adjoining space, in particular a percussion mechanism space. A “percussion mechanism space” in this context is to be understood to mean, in particular, a space that at least partially surrounds the hammer tube of the percussion mechanism. The percussion mechanism space may be at least partially delimited by a percussion mechanism housing. The percussion mechanism housing may be part of the hand power-tool housing and/or of a transmission housing. The transmission housing may be a constituent part of the hand power-tool housing. Preferably, the venting openings may be provided for equalizing the pressure of the percussion space with that of the percussion mechanism space. Preferably, the idling openings may be provided, when in the idling mode, to equalize the pressure of the compression space with that of the percussion mechanism space. The pressure sensor unit may be provided to measure the pressure characteristic in the percussion mechanism space. The pressure characteristic in the percussion mechanism space is influenced, in particular, by the movement of the piston and/or the striker, depending on the operating mode. The pressure characteristic can be particularly suitable for identifying the percussion mechanism state. Depending on the operating mode, the percussion mechanism space is connected in respect of pressure to the compression space and the percussion space in a particularly direct manner. The pressure characteristic in the percussion mechanism space can be particularly characteristic of the percussion mechanism state.

Further, it is proposed that the pressure sensor unit be provided to measure the pressure characteristic in a transmission space that, in at least one percussion mechanism state, is connected in respect of pressure to at least the percussion space delimited by the piston and/or to the compression space. A “transmission space” in this context is to be understood to mean, in particular, a space that preferably adjoins the percussion mechanism space and that, in particular, surrounds the transmission unit of the drive unit. The transmission unit may be provided, in particular, to generate a cyclic movement of the piston from a driving motion of a motor of the drive unit. The transmission unit may comprise, in particular, an eccentric gear mechanism and/or a connecting rod. The transmission space is preferably connected in respect of pressure to the percussion mechanism space, in particular via one or more throttle points. A “throttle point” in this context is to be understood to mean, in particular, a constriction of a flow cross section in a transitional region between two spaces. The pressure characteristic in the transmission space can be influenced by the pressure characteristic in the percussion mechanism space. Via the percussion mechanism space, the transmission space is connected in respect of pressure to the compression space and/or the percussion space. The pressure characteristic in the transmission space can be characteristic of the percussion mechanism state. The transmission space and/or the percussion space may preferably have at least one percussion-mechanism venting means. The percussion-mechanism venting means is preferably realized as a pressure equalizing valve. The percussion-mechanism venting means is preferably provided to equalize the pressure of the transmission space and/or of the percussion mechanism space with that of an environment. In particular, pressure equalization may occur if a defined pressure difference is exceeded, and/or may occur via a throttle point. The throttle point may be provided for the pressure in the percussion mechanism housing and/or transmission housing to match, on average, an ambient pressure. The control unit may preferably be disposed in or close to the transmission space. The signal processing unit of the pressure sensor unit and/or the pressure sensor of the pressure sensor unit may be disposed on a circuit board of the pressure sensor unit. The pressure sensor may be disposed at the measurement location at which the pressure characteristic is to be measured, or preferably be connected in respect of pressure to the measurement location. The connection in respect of pressure may be realized as a channel, tube or, preferably, as a flexible tube. A flexible measurement tube may lead from the pressure sensor unit to the measurement location. A particularly inexpensive arrangement of the pressure sensors can be achieved. The pressure sensor can be disposed such that it is particularly well protected. Fouling of the pressure sensor, in particular with lubricants from the transmission space and/or the percussion mechanism space, can be avoided. Preferably, the measurement location and/or the pressure sensor can be disposed in or in the region of the percussion-mechanism venting means. The percussion-mechanism venting means can be protected against fouling, in particular by lubricants. Protection against fouling by lubricants can protect the pressure sensor and the percussion-mechanism venting means.

Further, it is proposed that the control unit be provided to evaluate an amplitude of the pressure characteristic. An “amplitude” in this context is to be understood to mean, in particular, a maximum excursion of the pressure characteristic during a time interval, between a minimum and a maximum. The “time interval” preferably corresponds at least to the time interval of a percussion cycle, and is preferably shorter than 50 percussion cycles, particularly preferably shorter than 10 percussion cycles. A “percussion cycle” is to be understood to mean a time interval of two percussive impulses in the percussive operating state and/or a cyclic piston movement at the percussion frequency and/or percussion-mechanism rotational speed in the percussive operating state or in the idling operating state. The pressure may fluctuate, in particular, as a result of movements of the striker and/or of the piston and/or movements of other components that influence the volume of the percussion mechanism space and/or transmission space and/or of other spaces connected in respect of pressure to the percussion mechanism space and/or transmission space. The amplitude may be influenced, in particular, by a total volume of the spaces connected in respect of pressure. The amplitude can be a particularly good measure for identification of a percussion mechanism state.

Further, it is proposed that the control unit be provided to evaluate a frequency spectrum of the pressure characteristic. A “frequency spectrum” in this context is to be understood to mean, in particular, a frequency spectrum of the pressure characteristic during the described time interval. Frequencies in the pressure characteristic can be influenced, in particular, by movements of the striker and/or of the piston, and/or can be dependent on the percussion frequency. In particular, the control unit can evaluate the frequency spectrum in that the amplitude of defined frequencies in the frequency spectrum is evaluated. The defined frequencies may be, in particular, the percussion frequency determined by the percussion-mechanism rotational speed and/or multiples thereof. For the purpose of evaluating defined frequencies, the control unit preferably has threshold values, with which the amplitudes are compared. The threshold values are preferably settable. The frequency spectrum may include features that are particularly suitable for identifying a percussion mechanism state.

Further, it is proposed that the control unit be provided to use the pressure characteristic to determine the operating mode. The percussion mechanism space and/or transmission space can be connected in respect of pressure to the percussion space when in the idling mode, and to the percussion space and the compression space when in the percussion mode. A total volume of the spaces connected in respect of pressure can be less in the percussion mode than in the idling mode. The amplitude of the pressure characteristic can be greater in the percussion mode than in the idling mode. The control unit can identify the percussion mode if the amplitude is greater than a limit value. The limit value is preferably defined such that it is not attained in the idling mode and is exceeded in the percussion mode. Further, it is proposed that the control unit be provided to use the pressure characteristic to determine a change of operating mode from the idling mode to the percussion mode. The striking pin may preferably be mounted so as to be displaceable in the hammer tube. The striking pin may preferably be connected to the control sleeve. If the tool is pressed against a workpiece, the tool can preferably displace the striking pin, contrary to the percussion direction, such that the striking pin displaces the control sleeve, contrary to the percussion direction, from an idling position to a percussion position. In the percussion position, the control sleeve can close the idling opening, at least to a large extent. The displacement of the striking pin contrary to the percussion direction can reduce, at least temporarily, a distance between the striking pin and the striker, and consequently the volume of the percussion space enclosed by the striker and the striking pin in the hammer tube. The total volume of the percussion space and percussion mechanism space and/or transmission space can be reduced, at least temporarily. The pressure characteristic in the percussion mechanism space and/or transmission space can have a pressure increase, at least temporarily. The control unit can evaluate the pressure increase and identify a switchover from the idling mode to the percussion mode. The control unit can reliably identify the percussion mode and/or the idling mode of the percussion mechanism.

Further, it is proposed that the control unit be provided to use the pressure characteristic to determine the operating state. In particular, the control unit can be provided to identify a percussive operating state from the pressure characteristic. In particular, the striker can cause a pressure wave upon a rebound from the striking pin. The pressure wave can influence the frequency spectrum of the pressure characteristic. In particular, in the percussive operating state, the pressure characteristic can have a frequency component having double the percussion frequency. The control unit may be provided, in particular, to evaluate the frequency component having double the percussion frequency, for the purpose of identifying percussion. The percussive operating state can be identified if the frequency component having double the percussion frequency is greater than a threshold value assigned to this frequency component for evaluation. The frequency component can be determined from the measurement of the pressure characteristic, preferably by a Fourier transformation, particularly preferably by a 1-point Fourier transformation with double the percussion frequency. Reliable identification of the percussive operating state can be achieved. In particular, the control unit can verify, in the percussion mode, whether the percussion mechanism is in the percussive operating state and/or whether a starting of the percussion mechanism was successful.

Further, it is proposed that the control unit be provided to set the percussion-mechanism rotational speed to a starting value, in at least one operating state, for the purpose of changing from the idling operating state to the percussive operating state. Preferably, the starting value can be set temporarily, at least until successful starting of the percussion mechanism is achieved. A “starting value” in this context is to be understood to mean, in particular, a percussion frequency that is suitable for a reliable starting of the percussion mechanism. “Reliable” in this context is to be understood to mean, in particular, that, when the percussion mechanism is switched over from the idling mode to the percussion mode, the percussive operating state ensues in more than 90%, preferably in more than 95%, particularly preferably in more than 99% of cases. In particular, an excessively high percussion-mechanism rotational speed may be unsuitable for a starting of the percussion mechanism. The percussion-mechanism rotational speed above which a starting of the percussion mechanism fails may depend on the type of percussion mechanism and, in particular, on an ambient pressure. In the idling mode, the percussion-mechanism rotational speed can be set to an idling value. In the percussion mode, the percussion-mechanism rotational speed can be set to a working value. The working value can be set in dependence on a mode of performing work and/or a material to be worked and/or a tool type. The idling value and the working value may be identical. The idling value may be increased, in particular in order to achieve better cooling of the percussion mechanism as a result of a higher rotational speed of a fan unit driven by the drive unit. If the control unit identifies a change of the operating mode, from the idling mode to the percussion mode, and the change from the idling operating state to the percussive operating state fails, the control unit can lower the percussion-mechanism rotational speed to the starting value. Once starting of the percussion mechanism has occurred, the control unit can set the percussion-mechanism rotational speed to the working value. Reliability of the percussion mechanism can be increased. A performance capability of the percussion mechanism can be increased.

Further, it is proposed that the control unit be provided to use the pressure characteristic to determine a servicing state. A “servicing state” in this context is to be understood to mean, in particular, a state of wear of the percussion mechanism. In particular, the control unit may be provided to identify a need for repairs and/or servicing and cleaning of the percussion mechanism. In particular, the control unit may be provided to determine the state of a percussion-mechanism venting means. The percussion-mechanism venting means, in the case of correct functioning, can avoid a rise in a mean pressure in the percussion mechanism space and/or transmission space as a result of a temperature rise. The control unit may be provided, in particular, to evaluate a mean value of the pressure characteristic. If the mean value increases over a defined time interval and/or if it exceeds a threshold value, the control unit can output a servicing signal and alert the user concerning a malfunction of the percussion-mechanism venting means. Persons skilled in the art will use the pressure characteristic to define other appropriate servicing states that can be signaled to the user by the control unit. A malfunction and/or incipient malfunction can be identified in a reliable manner. Servicing of the percussion mechanism can be performed in a timely manner. Operating failures can be avoided.

Further, it is proposed that the pressure sensor unit be provided additionally to measure a temperature. A “temperature” in this context is to be understood to mean, in particular, an ambient temperature at the place of application of the percussion mechanism. In particular, the pressure sensor can comprise a temperature sensor. The temperature may affect the operation of the percussion mechanism. In particular, a viscosity of lubricants and/or a friction of the striker movement may be dependent on temperature. Admissible working values and starting values of the percussion-mechanism rotational speed may be dependent on temperature. The control unit can define the starting value and the working value in dependence on temperature. The reliability of the percussive operating state and/or of the starting of the percussion mechanism can be increased. The performance capability of the percussion mechanism can be improved. Preferably, for the purpose of measuring temperature, the pressure sensor unit uses a temperature sensor that is provided for temperature-dependent sensor compensation of the pressure sensor. This avoids the need for a further temperature sensor.

Further, it is proposed that the pressure sensor unit be provided additionally to measure the ambient pressure. An “ambient pressure” in this context is to be understood to mean, in particular, at air pressure at a place of application of the percussion mechanism. The air pressure may affect a mean pressure in the spaces in the hammer tube that are delimited by the striker. In particular, the air pressure may affect the pressure in a space disposed in front of the striker in the percussion direction. The air pressure may influence, in particular, the movement of the striker in the return direction. In particular, depending on the air pressure, the movement in the return direction may be inadmissible in the case of excessively high percussion-mechanism rotational speeds. In particular, the admissible starting value of the percussion-mechanism rotational speed may be dependent on air pressure. The control unit can define the starting value and the working value in dependence on air pressure. The reliability of the percussive operating state and/or of the starting of the percussion mechanism can be increased. The performance capability of the percussion mechanism can be improved.

Further, it is proposed that the control unit be provided to use the pressure characteristic to determine the percussion frequency. In particular, the control unit can determine the percussion frequency from the frequency spectrum of the pressure characteristic. The frequency spectrum comprises a frequency component that corresponds to the percussion frequency. In the percussive operating state, in particular, the frequency spectrum may comprise a further frequency component, which corresponds to double the percussion frequency. The control unit can determine the percussion frequency, in that it evaluates maxima of the frequency spectrum in the range of the possible percussion frequency and/or in the range of double the amount of the possible percussion frequency. The percussion frequency determined from the pressure characteristic can be used to determine the percussion-mechanism rotational speed and/or can be used to control the drive unit by open-loop and/or closed loop control. The percussion frequency determined from the pressure characteristic can be used as a direct open-loop and closed-loop control variable for rotational speed control. There is no need for a sensor for determining the percussion-mechanism rotational speed. Preferably, the percussion-mechanism rotational speed determined from the pressure characteristic can be compared with the rotational speed signal of the drive unit. Operational malfunctions can be identified.

Additionally proposed is a hand power tool comprising a percussion mechanism unit, having the properties described. The hand power tool may have the advantages described.

Additionally proposed is a method for operating a percussion mechanism, having the features described. The method may have the advantages described.

### DRAWING

Further advantages are given by the following description of the drawing. The drawing shows an exemplary embodiment of the invention. The drawing, the description and the claims contain numerous features in combination. Persons skilled in the art will also expediently consider the features individually and combine them to create appropriate further combinations.

There are shown in the drawing:

FIG. 1 a schematic representation of a rotary and percussion hammer having a percussion mechanism unit according to the invention, in a first exemplary embodiment, in an idling mode,

FIG. 2 a schematic representation of the rotary and percussion hammer in a percussion mode,

FIG. 3 a schematic representation of a pressure characteristic in the idling mode, in an idling operating state,

FIG. 4 a schematic representation of the pressure characteristic in the percussion mode, in a percussive operating state, and

FIG. 5 a schematic representation of a frequency spectrum of the pressure characteristic in the idling operating state and in the percussive operating state.

### DESCRIPTION OF THE EXEMPLARY EMBODIMENT

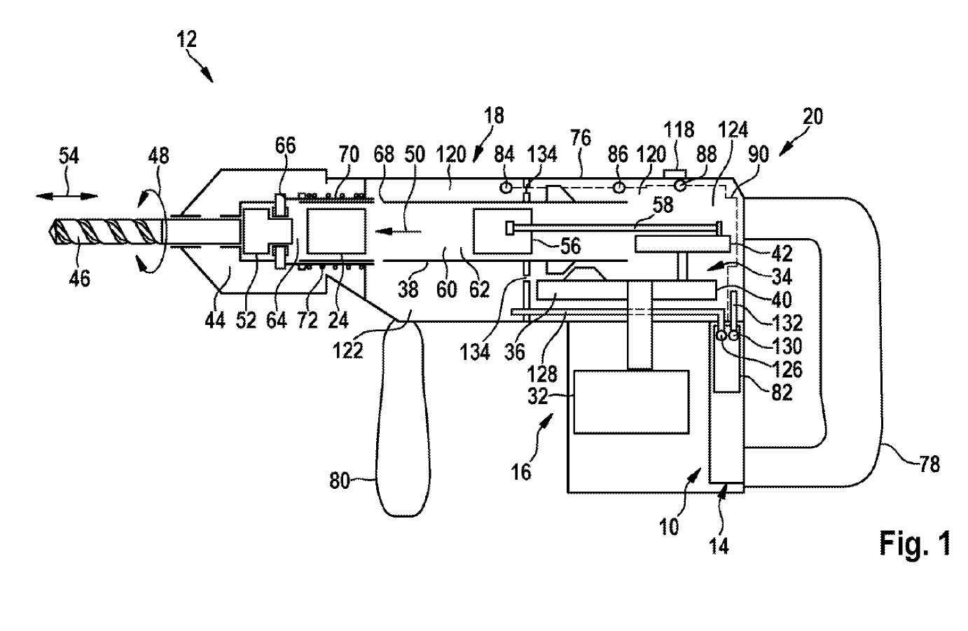

FIG. 1 shows a rotary and percussion hammer 12, comprising a percussion mechanism unit 10. The percussion mechanism unit 10 comprises a control unit 14, which is provided to control a drive unit 16 of a pneumatic percussion mechanism 18.

The drive unit 16 comprises a motor 32, having a transmission unit 34 that drives a hammer tube 38 in rotation via a first gear wheel 36 and drives an eccentric 42 via a second gear wheel 40. The hammer tube 38 is connected in a rotationally fixed manner to a tool holder 44, in which a tool 46 can be clamped. For a drilling operation, the tool holder 44 and the tool 46 can be driven with a rotary working motion 48, via the hammer tube 38. If, in a percussive operating state, a striker 24 is accelerated in a percussion direction 50, in the direction of the tool holder 44, upon impacting upon a striking pin 52 that is disposed between the striker 24 and the tool 46 it exerts a percussive impulse that is transmitted from the striking pin 52 to the tool 46. As a result of the percussive impulse, the tool 46 exerts a percussive working motion 54. A piston 56 is likewise movably mounted in the hammer tube 38, on the side of the striker 24 that faces away from the percussion direction 50. Via a connecting rod 58, the piston 56 is moved periodically in the percussion direction 50 and back again in the hammer tube 38, by the eccentric gear mechanism 42 driven with a percussion-mechanism rotational speed. The piston 56 compresses a pressure cushion 62 enclosed in a compression space 60, between the piston 56 and the striker 24, in the hammer tube 38. Upon a movement of the piston 24 in the percussion direction 50, the striker 24 is accelerated in the percussion direction 50. A percussive operating state 94 can commence (FIG. 4). The striker 24 can be moved back again, contrary to the percussion direction 50, by a rebound on the striking pin 52 and/or by a negative pressure that is produced between the piston 56 and the striker 24 as a result of the return movement of the piston 56, contrary to the percussion direction 50, and/or by a counter-pressure in a percussion space 64 between the striker 24 and the striking pin 52, and can then be accelerated for a subsequent percussive impulse back in the percussion direction 50. Whether the movements, and in particular the percussive operating state 94, occur, depends on operating parameters, in particular the percussion-mechanism rotational speed. In the case of an excessively high percussion-mechanism rotational speed, the striker 24 cannot follow the movement excited by the piston 56, such that the percussive operating state fails. For starting of the percussion mechanism, the percussion-mechanism rotational speed then must be reduced to a lower starting value.

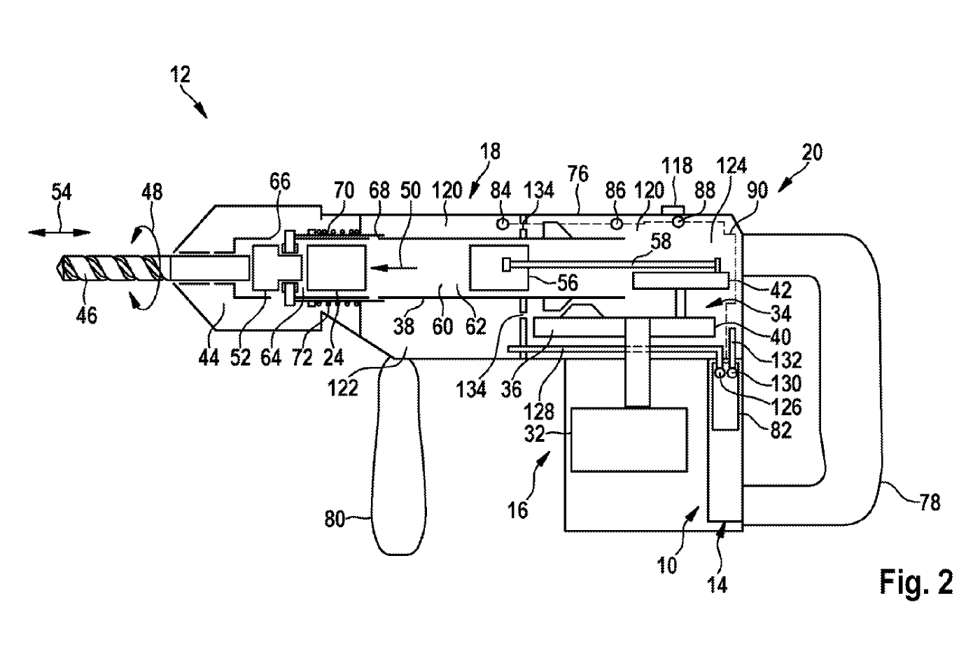

Venting openings 66 are disposed in the hammer tube 38, in a region between the striker 24 and the striking pin 52, such that the air enclosed between the striker 24 and the striking pin 52 can escape. Idling openings 68 are disposed in the hammer tube 38, in a region between the striker 24 and the piston 56. The tool holder 44 is mounted so as to be displaceable in the percussion direction 50, and is supported on a control sleeve 70. A spring element 72 exerts a force upon the control sleeve 70, in the percussion direction 50. In a percussion mode (FIG. 2), in which the tool 46 is pressed against a workpiece by a user, the tool holder 44 displaces the control sleeve 70 against the force of the spring element 72 such that it covers the idling openings 68. If the tool 46 is taken off the workpiece, the tool holder 44 and the control sleeve 70 are displaced by the spring element 72 in the percussion direction 50, into an idling mode (FIG. 1), such that the control sleeve 70 releases the idling openings 68. A pressure in the pressure cushion 62 between the piston 56 and the striker 24 can escape through the idling openings 68. In the idling mode, the striker 24 is not accelerated, or is accelerated only slightly, by the pressure cushion 62 (FIG. 1). In the idling operating state 92, the striker 24 does not exert any percussive impulses, or exerts only slight percussive impulses, upon the striking pin 52. The rotary and percussion hammer 12 has a hand power-tool housing 76, having a handle 78 and an ancillary handle 80, by which it is guided by a user.

A pressure sensor unit 20 is provided to measure a pressure characteristic 22, for the purpose of identifying at least one percussion mechanism state. The pressure sensor unit 20 is provided to measure the pressure characteristic 22 in a space 120 that, in at least one percussion mechanism state, is connected in respect of pressure to at least the percussion space 64 delimited by the piston 56 and/or to the compression space 60. The pressure sensor unit 20 is provided to measure the pressure characteristic 22 in a transmission space 124 that, in at least one percussion mechanism state, is connected in respect of pressure to at least the percussion space 64 delimited by the piston 24 and/or to the compression space 60. The pressure sensor unit 20 comprises a signal processing unit 82, disposed on the control unit 14, and pressure sensors 84, 86, 88, 126 and 130. Since the measurement is effected by means of a plurality of pressure sensors 84, 86, 88, 126 and 130, the pressure sensor unit 20 can identify the percussion mechanism state in a particularly reliable manner. It is also possible, however, to realize the invention with only one, or only some, of the pressure sensors 84, 86, 88, 126 and 130. Persons skilled in the art will select the appropriate location and the appropriate number of pressure sensors 84, 86, 88, 126 and 130.

The pressure sensor 84 is disposed in a percussion mechanism space 122. The percussion mechanism space 122 surrounds the hammer tube 38, and is connected in respect of pressure to the percussion space 64, via the venting openings 66. In the idling mode, the percussion space 122 is connected in respect of pressure to the compression space 60, via the idling opening 68. The transmission space 124 adjoins the percussion space 122, on the side that faces toward the eccentric 42. The transmission space 124 surrounds the transmission unit 34 with the gear wheels 36, 40 and the eccentric 42. The percussion space 122 and the transmission space 124 are connected in respect of pressure via throttle points 134. The percussion mechanism space 122 and the transmission space 124 are inside the hand power-tool housing 76. Disposed in the region of the transmission space 124 is a percussion-mechanism venting means 118, which is provided to equalize pressure with that of an environment of the rotary and percussion hammer 12. The percussion-mechanism venting means 118 is realized as a pressure relief valve, which opens if a defined pressure difference is exceeded. The pressure sensor 86 is disposed in the transmission space 124, and measures the pressure characteristic 22 of the transmission space 124. The pressure sensor 88 is disposed on the side of the pressure relief valve of the percussion-mechanism venting means 118 that faces toward the transmission space 124, and likewise measures the pressure characteristic 22 of the transmission space 124. The pressure sensors 84, 86 and 88 are connected to the signal processing unit 82 via a signal connection 90. Further, the pressure sensors 126 and 130 are disposed on the signal processing unit 82. The pressure sensor 126 is connected to the percussion mechanism space 122 by means of a flexible pressure tube 128. The pressure sensor 130 is connected to the transmission space 124 by means of a flexible pressure tube 132. The pressure sensors 126, 130 are particularly well protected against fouling by grease from the transmission space 124 or the percussion mechanism space 122. Since the percussion mechanism space 122 and the transmission space 124 are connected in respect of pressure via the throttle points 134, the pressure in the percussion mechanism space 122 differs only slightly from that in the transmission space 124. In the following, the pressure characteristic 22 in the transmission space 124 is described. Pressure characteristics in the percussion mechanism space 122 can be used in a similar manner for identifying the percussion mechanism state, and differ only negligibly.

The control unit 14 is provided to evaluate an amplitude 26 and a frequency spectrum 28 of the pressure characteristic 22. The control unit 14 is provided to use the pressure characteristic 22 to determine an operating mode and an operating state.

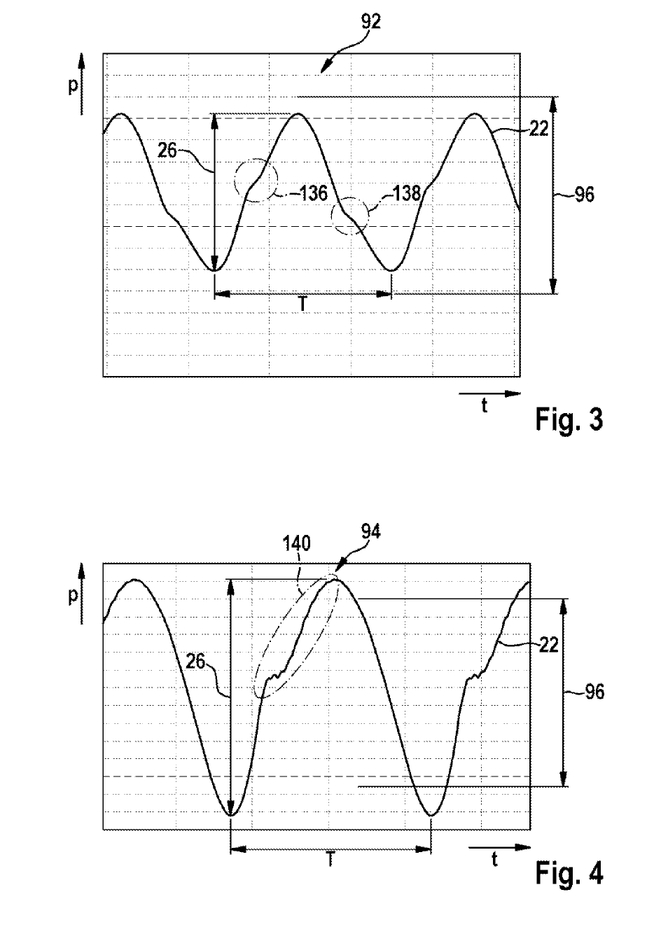

FIG. 3 shows a schematic representation of the pressure characteristic 22 in the idling mode, in the case of the idling operating state 92. The pressure characteristic 22 has a sinusoidal oscillation, the frequency corresponding to the percussion-mechanism rotational speed of the eccentric 42, and thus to a movement cycle of the piston 56. The compression space 60, the percussion space 64, the percussion mechanism space 122 and the transmission space 124 are connected in respect of pressure. In particular, the movement of the piston 56 at the frequency of the percussion-mechanism rotational speed causes the pressure characteristic 22. The striker 24 moves freely and, in the falling flank and rising flank of the pressure characteristic 22, causes slight deviations from the sinusoidal characteristic, in regions 136 and 138 in each case. A period T of the pressure characteristic corresponds to one revolution of the percussion mechanism. The percussion mechanism frequency is 1/T.

FIG. 4 shows a schematic representation of the pressure characteristic 22 in the percussion mode, in the case of the percussive operating state 94. The pressure characteristic 22 has a sinusoidal oscillation, the frequency corresponding to the percussion-mechanism rotational speed of the eccentric 42, and thus to a movement cycle of the piston 56. The percussion space 64, the percussion mechanism space 122 and the transmission space 124 are connected in respect of pressure. Consequently, the volume of the spaces connected in respect of pressure is less than in the idling mode, since the compression space 60 has been sealed off from the percussion space 64 by the idling opening 68 closed by the control sleeve 70. Owing to the lesser volume, the amplitude 26 in the percussion mode is greater than in the idling mode (FIG. 3). In the percussive operating state 94, the striker 24 rebounds strongly from the striking pin 52. The rebound causes a pronounced deviation of the pressure characteristic 22 from the sinusoidal waveform in the region 140 of its rising flank.

The control unit 14 compares the amplitude 26 with a threshold value 96. In the idling mode (FIG. 3), the amplitude 26 is less than the threshold value 96; the control unit 14 identifies the idling mode. In the percussion mode (FIG. 4), the amplitude 26 is greater than the threshold value 96; the control unit 14 identifies the percussion mode. In the case of a change from the idling mode to the percussion mode, the change in volume caused by the movement of the striking pin 52 likewise causes a fluctuation in the pressure characteristic 22, not represented here, which the control unit 14 can likewise use to identify the change from the idling mode to the percussion mode.

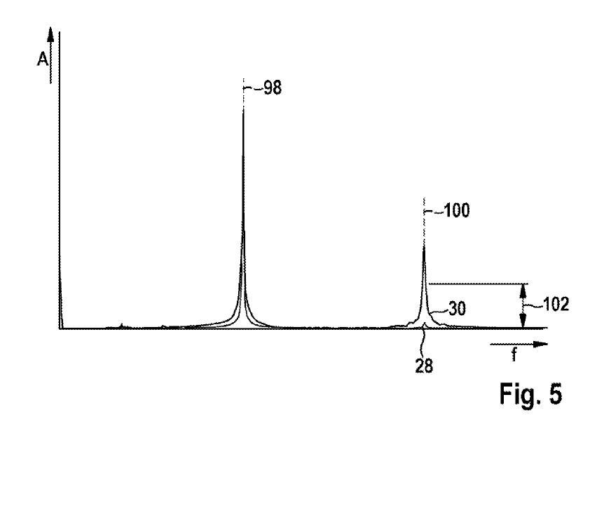

FIG. 5 shows the frequency spectrum 28 of the pressure characteristic 22 in the idling mode, and a frequency spectrum 30 of the pressure characteristic 22 in the percussion mode. In the idling operating state, the frequency spectrum 28 has a frequency component 98 that corresponds to the percussion frequency, or percussion-mechanism rotational speed. In the percussive operating state, the frequency spectrum 30 has an additional frequency component 100, which corresponds to double the percussion frequency. This frequency component 100 is caused by the pronounced deviation of the pressure characteristic 22 from the sinusoidal waveform in the region 140, resulting from the rebound of the striker 24 from the striking pin 52, and characterizes the percussive operating state. The control unit 14 identifies the frequency component 100 by a Fourier transformation of the pressure characteristic 22 with double the percussion frequency. If the frequency component 100 exceeds a threshold value 102, the control unit 14 identifies the percussive operating state.

The control unit 14 is provided, in at least one percussion mechanism state, to set the percussion-mechanism rotational speed to a starting value for the purpose of changing from the idling operating state 92 to the percussive operating state 94. If the control unit 14 identifies a change from the idling mode to the percussion mode without the occurrence of a subsequent change from the idling operating state 92 to the percussive operating state 94, the control unit 14 reduces the percussion-mechanism rotational speed to the starting value. The starting value is selected such that reliable starting of the percussion mechanism is effected under all conditions. If the control unit 14 identifies the percussive operating state 94, it sets the percussion-mechanism rotational speed set by the user. The pressure sensor unit 20 is provided to measure an ambient pressure and an ambient temperature. The ambient pressure and the ambient temperature affect the percussion-mechanism rotational speed at which reliable starting of the percussion mechanism is possible. The control unit 14 defines the starting value in dependence on the ambient pressure and ambient temperature. For this purpose, stored on the control unit 14 there are families of characteristics, which contain admissible starting values in dependence on ambient pressure and ambient temperature.

Further, the control unit 14 is provided to use the pressure characteristic 22 to determine a servicing state. The percussion-mechanism venting means 118 serves to equalize the pressure of the transmission space 124 with that of an environment. If there is fouling of the percussion-mechanism venting means 118, the pressure in the transmission space 124 increases. The control unit 14 forms a mean value of the pressure characteristic 22. If the mean value of the pressure characteristic 22 exceeds a set threshold value for a mean pressure value, a signal is output to the user, on a display unit that is not represented in greater detail, that the percussion-mechanism venting means 118 must be serviced.

Further, the control unit 14 is provided to use the pressure characteristic 22 to determine the percussion frequency. The percussion frequency corresponds to the frequency of the frequency component 98 of the pressure characteristic 22 (FIG. 5). The control unit 14 compares the percussion-mechanism rotational speed determined from the pressure characteristic 22 with a set setpoint rotational speed, and uses this as a feedback variable of a closed-loop control unit, disposed on the control unit 14, for the drive unit 16.

1. A percussion mechanism unit, comprising:
a control unit configured to control one or more of a drive unit and a pneumatic percussion mechanism by one or more of open-loop control and closed-loop control; and
a pressure sensor unit configured to measure a pressure characteristic in order to identify at least one percussion mechanism state.

2. The percussion mechanism unit as claimed in claim 1, wherein the pressure sensor unit is configured to measure the pressure characteristic in a space that, in at least one percussion mechanism state, is connected in respect of pressure to at least one percussion space and/or compression space delimited by a piston.

3. The percussion mechanism unit as claimed in claim 2, wherein the pressure sensor unit is configured to measure the pressure characteristic in a transmission space that, in at least one percussion mechanism state, is connected in respect of pressure to at least the percussion space delimited by the piston and/or to the compression space.

4. The percussion mechanism unit as claimed in claim 1, wherein the control unit is configured to evaluate an amplitude of the pressure characteristic.

5. The percussion mechanism unit as claimed in claim 1, wherein the control unit is configured to evaluate a frequency spectrum of the pressure characteristic.

6. The percussion mechanism unit as claimed in claim 1, wherein the control unit is provided configured to use the pressure characteristic to determine an operating mode.

7. The percussion mechanism unit as claimed in claim 1, wherein the control unit is configured to use the pressure characteristic to determine an operating state.

8. The percussion mechanism unit as claimed in claim 1, wherein the control unit is configured to set the percussion-mechanism rotational speed to a starting value, in at least one percussion mechanism state, in order to change from an idling operating state to a percussive operating state.

9. The percussion mechanism unit as claimed in claim 1, wherein the control unit is configured to use the pressure characteristic to determine a servicing state.

10. The percussion mechanism unit as claimed in claim 1, wherein the pressure sensor unit is further configured to measure a temperature.

11. The percussion mechanism unit as claimed in claim 1, wherein the pressure sensor unit is further configured to measure an ambient pressure.

12. The percussion mechanism unit as claimed in claim 1, wherein the control unit is configured to use the pressure characteristic to determine a percussion frequency.

13. A hand power tool, comprising:
a percussion mechanism unit including:
a control unit configured to control one or more of a drive unit and a pneumatic percussion mechanism by one or more of open-loop control and closed-loop control; and
a pressure sensor unit configured to measure a pressure characteristic in order to identify at least one percussion mechanism state.

14. A method for operating a percussion mechanism unit, comprising:
controlling one or more of a drive unit and a pneumatic percussion mechanism by one or more of open-loop control and closed-loop control; and
measuring a pressure characteristic in order to identify at least one percussion mechanism state.

15. The percussion mechanism unit as claimed in claim 1, wherein the percussion mechanism unit is configured for one or more of a rotary hammer and a percussion hammer.
